(19) United States
(12) Patent Application Publication
(10) Pub. No.: US 2025/0293943 A1
(43) Pub. Date: Sep. 18, 2025

(54) FEDERATED LEARNING METHODS APPLICABLE FOR RADIO ACCESS NETWORK PERFORMANCE OPTIMIZATION

(71) Applicant: Nokia Technologies Oy, Espoo (FI)

(72) Inventors: Kalle Petteri KELA, Espoo (FI); Hans Thomas HÖHNE, Espoo (FI); Teemu Mikael VEIJALAINEN, Espoo (FI)

(21) Appl. No.: 18/860,427

(22) PCT Filed: Apr. 26, 2022
(86) PCT No.: PCT/EP2022/060992

§ 371 Date: Oct. 25, 2024

(51) Int. Cl. H04L 41/16; H04W 24/02

(52) U.S. Cl. CPC H04L 41/16; H04W 24/02

(57) ABSTRACT

Techniques of updating machine learning models in a network include combining global and local models at each electronic entity of a network. For example, a first electronic entity (e.g., a user device) may train a local machine learning (ML) model based on data collected by the first electronic entity or other entities (e.g., other user devices, servers) and make predictions based on that model. Nevertheless, other electronic entities may also train or store their own local ML models. Accordingly, for more insight about the network and better predictability of the ML models, the first electronic entity may obtain a ML model from a second electronic entity, i.e., a global ML model. Upon receipt of the global ML model, the first electronic entity may aggregate the local ML model and the global ML model to produce an updated global ML model.

### TECHNICAL FIELD

This description relates to telecommunications systems.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's LTE upgrade path for mobile networks. In LTE, base stations or access points (APs), which are referred to as enhanced Node AP (eNBs), provide wireless access within a coverage area or cell. In LTE, mobile devices, or mobile stations are referred to as user equipment (UE). LTE has included a number of improvements or developments.

5G New Radio (NR) development is part of a continued mobile broadband evolution process to meet the requirements of 5G, similar to earlier evolution of 3G & 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example implementation, a method includes performing, by a first electronic entity of a plurality of electronic entities in a network, a training operation on a local dataset to produce local model coefficients of a local machine learning model, the local dataset being based on data collected by the first electronic entity of signals in the network, the local machine learning model being used by the first electronic entity in determining a performance metric for the first electronic entity within the network. The method also includes controlling transmitting, by the first electronic entity to a second electronic entity, a request for first global model coefficients of a first global machine learning model. The method further includes controlling receiving, by the first electronic entity from the second electronic entity, the first global model coefficients of the first global machine learning model. The method further includes aggregating, by the first electronic entity, the local model coefficients and the first global model coefficients to produce, as an aggregation, second global model coefficients of a second global machine learning model, the second global machine learning model being configured for use by the first electronic entity as an updated local machine learning model and the second electronic entity as an updated global machine learning model in determining the performance metric for the first electronic entity and the second electronic entity within the network.

According to an example implementation, an apparatus includes at least one processor and at least one memory including computer program code, the at least one memory and the computer program code configured to, with the at least one processor, cause the apparatus at least to perform, by a first electronic entity of a plurality of electronic entities in a network, a training operation on a local dataset to produce local model coefficients of a local machine learning model, the local dataset being based on data collected by the first electronic entity of signals in the network, the local machine learning model being used by the first electronic entity in determining a performance metric for the first electronic entity within the network. The at least one memory and the computer program code are also configured to, with the at least one processor, cause the apparatus at least to control transmitting, by the first electronic entity to a second electronic entity, a request for first global model coefficients of a first global machine learning model. The at least one memory and the computer program code are further configured to, with the at least one processor, cause the apparatus at least to control receiving, by the first electronic entity from the second electronic entity, the first global model coefficients of the first global machine learning model. The at least one memory and the computer program code are further configured to, with the at least one processor, cause the apparatus at least to aggregate, by the first electronic entity, the local model coefficients and the first global model coefficients to produce, as an aggregation, second global model coefficients of a second global machine learning model, the second global machine learning model being configured for use by the first electronic entity as an updated local machine learning model and the second electronic entity as an updated global machine learning model in determining the performance metric for the first electronic entity and the second electronic entity within the network.

According to an example implementation, an apparatus includes means for performing, by a first electronic entity of a plurality of electronic entities in a network, a training operation on a local dataset to produce local model coefficients of a local machine learning model, the local dataset being based on data collected by the first electronic entity of signals in the network, the local machine learning model being used by the first electronic entity in determining a performance metric for the first electronic entity within the network. The apparatus also includes means for controlling transmitting, by the first electronic entity to a second electronic entity, a request for first global model coefficients of a first global machine learning model. The apparatus further includes means for controlling receiving, by the first electronic entity from the second electronic entity, the first global model coefficients of the first global machine learning model. The apparatus further includes means for aggregating, by the first electronic entity, the local model coefficients and the first global model coefficients to produce, as an aggregation, second global model coefficients of a second global machine learning model, the second global machine learning model being configured for use by the first electronic entity as an updated local machine learning model and the second electronic entity as an updated global machine learning model in determining the performance metric for the first electronic entity and the second electronic entity within the network.

According to an example implementation, a computer program product includes a computer-readable storage medium and storing executable code that, when executed by at least one data processing apparatus, is configured to cause the at least one data processing apparatus to perform, by a first electronic entity of a plurality of electronic entities in a network, a training operation on a local dataset to produce local model coefficients of a local machine learning model, the local dataset being based on data collected by the first electronic entity of signals in the network, the local machine learning model being used by the first electronic entity in determining a performance metric for the first electronic entity within the network. The computer-readable storage medium also stores executable code that, when executed by at least one data processing apparatus, is configured to cause the at least one data processing apparatus to control transmitting, by the first electronic entity to a second electronic entity, a request for first global model coefficients of a first global machine learning model. The computer-readable storage medium further stores executable code that, when executed by at least one data processing apparatus, is configured to cause the at least one data processing apparatus to control receiving, by the first electronic entity from the second electronic entity, the first global model coefficients of the first global machine learning model. The computer-readable storage medium further stores executable code that, when executed by at least one data processing apparatus, is configured to cause the at least one data processing apparatus to aggregate, by the first electronic entity, the local model coefficients and the first global model coefficients to produce, as an aggregation, second global model coefficients of a second global machine learning model, the second global machine learning model being configured for use by the first electronic entity as an updated local machine learning model and the second electronic entity as an updated global machine learning model in determining the performance metric for the first electronic entity and the second electronic entity within the network.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a digital communications network according to an example implementation.

FIG. 2 is a flow chart illustrating a process of updating a client model, according to an example implementation.

FIG. 3 is a diagram illustrating a centralized federated learning loop, according to an example implementation.

FIG. 4 is a diagram illustrating a centralized federated learning process in which a global model is received from a server by clients, the global model is updated by the clients and transmitted back to the server, according to an example implementation.

FIG. 5 is a diagram illustrating a decentralized federated learning process in which a global model is received by a client from peer clients, the global model is updated by the client and transmitted back to the per clients, according to an example implementation.

FIG. 6 is a flow chart illustrating a process of updating a client model, according to an example implementation.

FIG. 7 is a sequence diagram illustrating a process of updating a client model that involves storing a global model at a server, according to an example implementation.

FIG. 8 is a flow chart illustrating a sequence diagram illustrating a process of updating a client model that involves peer-to-peer model circulation among peer clients, according to an example implementation.

FIG. 9 is a diagram illustrating a centralized federated learning process in which a global model is shared among more than one server, according to an example implementation.

FIG. 10 is a diagram illustrating a sharing of a global model within a cellular network, according to an example implementation.

FIG. 11 is a diagram illustrating a neural network used in beam selection, according to an example implementation.

FIG. 12 is a block diagram of a node or wireless station (e.g., base station/access point, relay node, or mobile station/user device) according to an example implementation.

### DETAILED DESCRIPTION

The principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

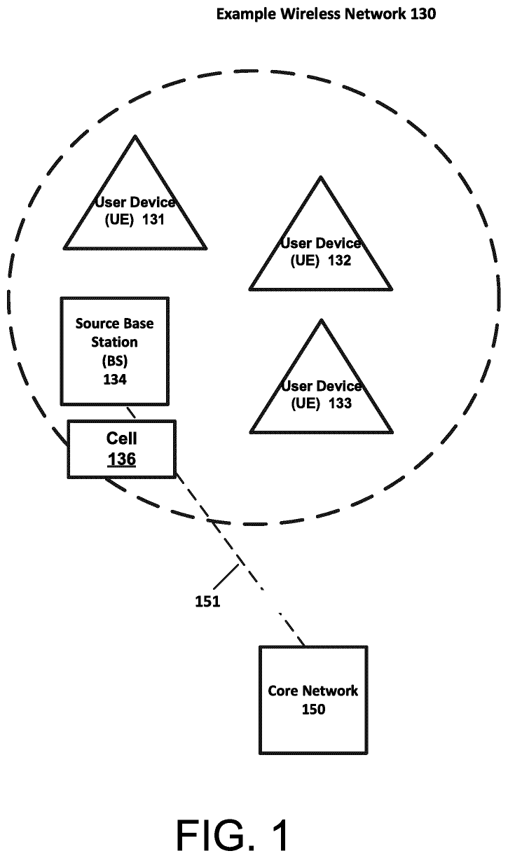

FIG. 1 is a block diagram of a digital communications system such as a wireless network 130 according to an example implementation. In the wireless network 130 of FIG. 1, user devices 131, 132, and 133, which may also be referred to as mobile stations (MSs) or user equipment (UEs), may be connected (and in communication) with a base station (BS) 134, which may also be referred to as an access point (AP), an enhanced Node B (eNB), a gNB (which may be a 5G base station) or a network node. At least part of the functionalities of an access point (AP), base station (BS) or (e) Node B (eNB) may also be carried out by any node, server or host which may be operably coupled to a transceiver, such as a remote radio head. BS (or AP) 134 provides wireless coverage within a cell 136, including the user devices 131, 132 and 133. Although only three user devices are shown as being connected or attached to BS 134, any number of user devices may be provided. BS 134 is also connected to a core network 150 via an interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a/centralized unit (CU) and/or a distributed unit (DU) in the case of a split BS or split gNB), or other network node.

According to an illustrative example, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node and sending data to and/or receiving data from one or more of the UEs. For example, after establishing a connection to a UE, a RAN node or network node (e.g., BS, eNB, gNB, CU/DU, . . . ) may forward data to the UE that is received from a network or the core network, and/or forward data received from the UE to the network or core network. RAN nodes or network nodes (e.g., BS, eNB, gNB, CU/DU, . . . ) may perform a wide variety of other wireless functions or services, e.g., such as broadcasting control information (e.g., such as system information or on-demand system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform.

A user device or user node (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. Also, a user node may include a user equipment (UE), a user device, a user terminal, a mobile terminal, a mobile station, a mobile node, a subscriber device, a subscriber node, a subscriber terminal, or other user node. For example, a user node may be used for wireless communications with one or more network nodes (e.g., gNB, eNB, BS, AP, DU, CU/DU) and/or with one or more other user nodes, regardless of the technology or radio access technology (RAT). In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. The protocol running between UE and CN is non-access stratum (NAS) protocols. Other types of wireless networks, such as 5G (which may be referred to as New Radio (NR)) may also include a core network. Generally, the 5G core architecture is similar to 4G core but 5G core gained some new capabilities and functions. One of the most significant difference between 4G and 5G core is the separation of control and use plane functions from each other. For instance, access and mobility management function (AMF) supports e.g., termination of NAS signaling, connection management, mobility management, etc. In 5G AMF works as a part of MME (4G core) and responsible to establish NAS signaling connection with UE and helps UE to register.

In addition, the techniques described herein may be applied to various types of user devices or data service types or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)-related applications may require generally higher performance than previous wireless networks.

Federated learning (FL) is a machine learning (ML) setting where multiple clients (e.g., mobile devices or whole organizations) collaboratively train a ML model under the orchestration of a central server (e.g., service provider) while keeping the training data decentralized. In centralized federated learning, clients (e.g., network entities such as nodes (gNBs) or user devices/equipment (UEs)) train their local models on local learning data (i.e. local experiences). Local model parameters such as neural network weights (and biases) are transmitted to the server, which orchestrates parameter collection from the clients and aggregation of the received model updates. After model aggregation, the server provides an updated global model to the clients.

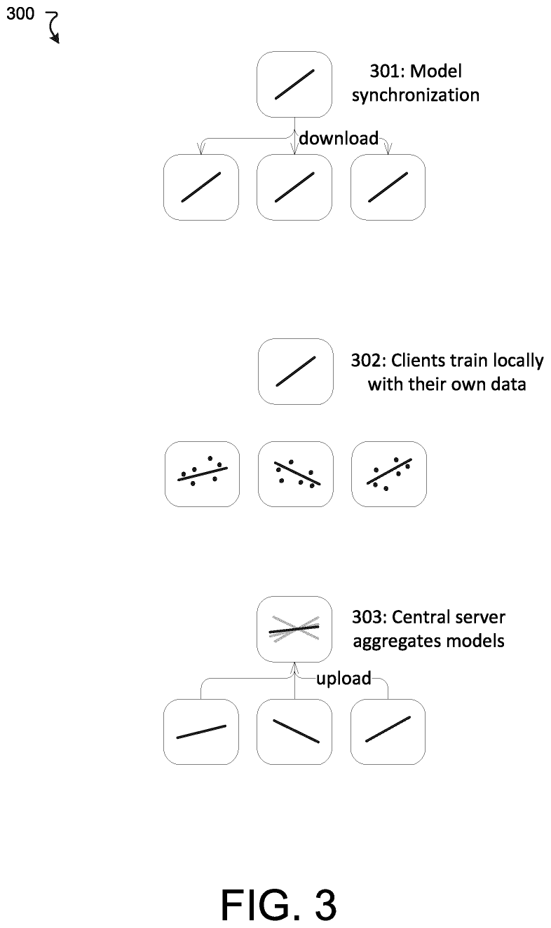

FIG. 3 illustrates an example conventional federalized learning loop 300. At 301, synchronized (i.e., global) models are received by clients. After the models are received, at 302, the clients train their local models with their respective local data. At 303, the resulting trained local models (i.e., model weights and biases) are transmitted to the server for aggregation. After aggregation. the server synchronizes the local models received form the clients to a latest aggregated (i.e., updated global) model.

It is noted that any electronic entity acting as a server may also use a learning rate to control the training of global models.

In decentralized federated learning, the clients may work together in order to obtain the global model. In this case, communication with the server is replaced with peer-to-peer communication between individual clients, which may communicate an aggregated model via a broadcast. Any client may act as a server, or the information is changed between neighbors. In practice, clients may share their local neural network parameters as such to the neighboring clients for combining, e.g., averaging. Neighboring clients may then perform the combining of model parameters (e.g., neural network weights) and distributing the averaged models back to the clients.

In some radio access networks, where the environment varies constantly, a single learning agent might not be able to learn independently optimal policies efficiently extensively enough for a desired purpose due to limited experiences. Also, sharing of raw learning data (experiences) is not resource efficient. Hence, it would be more efficient to share only neural network weights occasionally with entities that are learning towards the same target. Federated learning aims to solve these problems.

Nevertheless, there may be further problems with federated learning. For example, radio access network optimization tasks might benefit from a federated learning solution that is simple to standardize and works in centralized manner (e.g., a network entity orchestrating the learning of multiple gNBs or UEs) as well in decentralized manner (gNBs or UEs sharing models to each other). In other words, it may be beneficial to have federated learning method that does not necessarily need certain hierarchical network architectures. Moreover, to protect data privacy better it would be desirable if client models or training data would not be shared as such between servers or clients (e.g. between network entities or between UEs or between UEs and network entities).

Also, in federated learning it is known that synchronization of initial models helps learning when client models are subsequently aggregated together. Hence, there may need to be simple and efficient solutions to the problem of how the synchronization of the initial models can be arranged in environments where clients might be moving or learning environment constantly changes otherwise.

Accordingly, some pre-learned models may not work in different networks or in different geographical areas or with different type of network hardware. There may need to be rules that address situations in which aggregation is not allowed. And if aggregation is allowed, there may need to be rules addressing a rate at which models are aggregated.

In contrast to the conventional approach to federalized learning, improved techniques include combining global and local models at each electronic entity of a network. For example, a first electronic entity (e.g., a user device) may train a local machine learning (ML) model based on data collected by the first electronic entity or other entities (e.g., other user devices, servers) and make predictions based on that model. Nevertheless, other electronic entities may also train or store their own local ML models. Accordingly, for more insight about the network and better predictability of the ML models, the first electronic entity may obtain a ML model from a second electronic entity, i.e., a global ML model. Upon receipt of the global ML model, the first electronic entity may aggregate the local ML model and the global ML model to produce an updated global ML model.

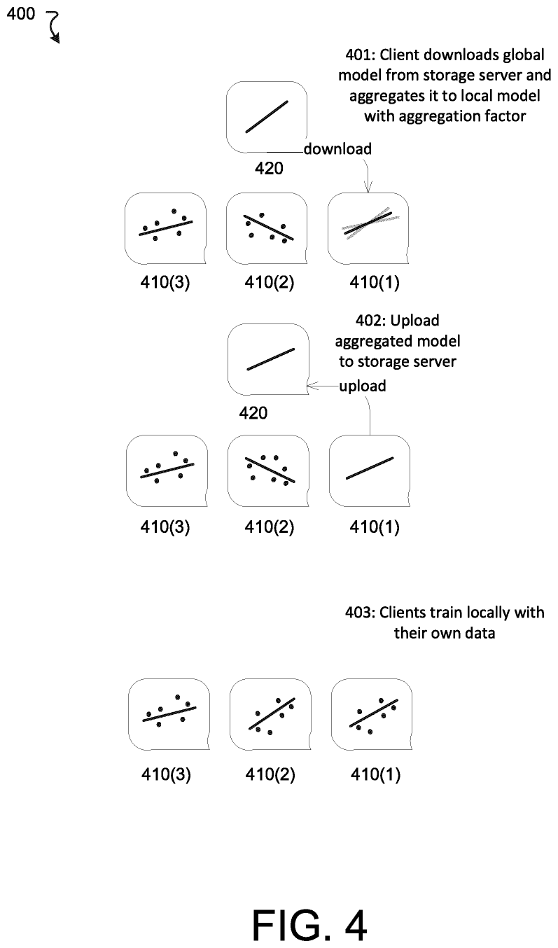

In some implementations, the second electronic entity is a server; in that case, the first electronic entity transmits the updated global ML model to the second electronic entity for storage or aggregation. Meanwhile, the first electronic entity may use the updated global ML model as an updated local ML model. Accordingly, another user device may obtain the updated global model, aggregate it with its own local ML model, and transmit that updated ML model. Further details about this implementation are shown in FIG. 4.

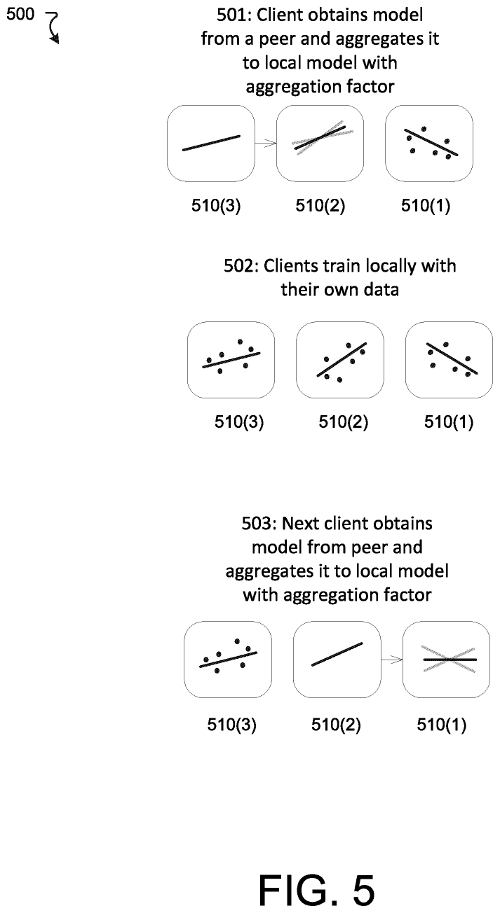

In some implementations, the second electronic entity is a peer user device. In this case, after obtaining and aggregating the global ML model from the peer user device, the first electronic entity may transmit the updated global ML model to another peer user device. Further details about this implementation are shown in FIG. 5.

The above-described improved technique for updating a ML model has advantages over the conventional approaches. For example, the improved techniques speed up the learning of models and allows combining different learning experiences into a single combined model. The improved technique may also enable applying the federated learning in situations such as when UEs are roaming between different network vendors or areas.

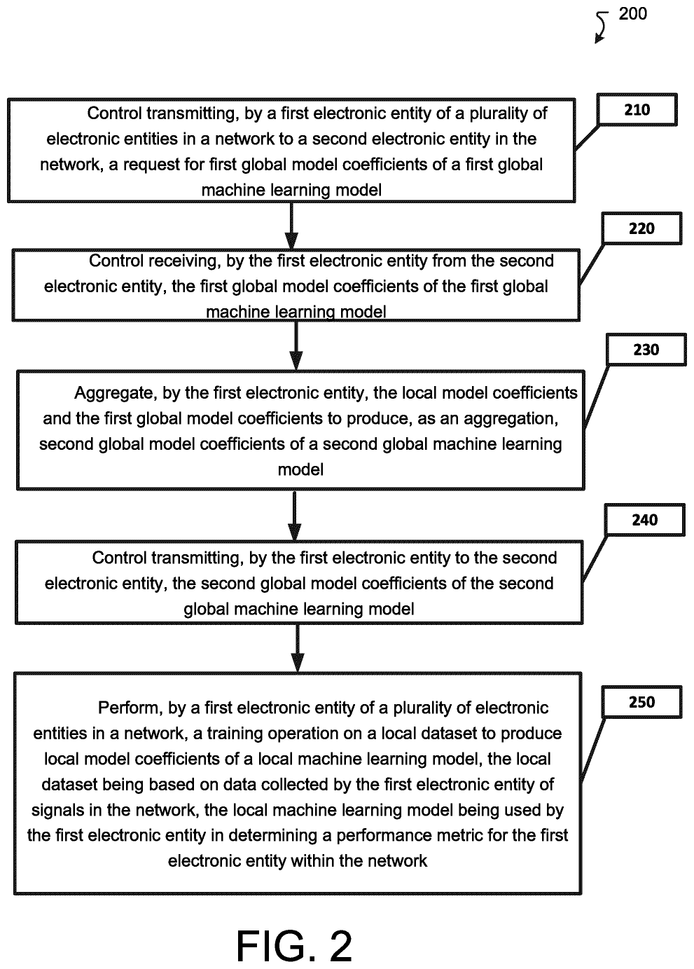

FIG. 2 is a flow chart illustrating a process 200 of updating a client model. The method described in FIG. 2 is written from the perspective of a first electronic entity in a network configured to train a local ML model and aggregate the local ML model with a global ML model obtained from a second electronic entity in the network to produce an updated global ML model.

Operation 210 includes controlling transmitting, by the first electronic entity to a second electronic entity, a request for first global model coefficients of a first global machine learning model. For example, the first electronic entity may transmit the request according to a fixed schedule; in some implementations, the schedule may be fixed according to a set of configuration parameters sent by a server in the network. Alternatively, the first electronic entity may transmit the request in response to a triggering event; the specification of the triggering event may also be done according to the set of configuration parameters.

Operation 220 includes controlling receiving, by the first electronic entity from the second electronic entity, the first global model coefficients of the first global machine learning model. In some implementations, the first and second electronic entities are network nodes; the first global model coefficients are received over an Xn interface. In some implementations, the first electronic entity is a network node distributed unit and the second electronic entity is a network node central unit; the first global model coefficients are received over a F1 interface. In some implementations, the first and second electronic entities are user devices; the first global model coefficients are received over a device-to-device link.

Operation 230 includes aggregating, by the first electronic entity, the local model coefficients and the first global model coefficients to produce, as an aggregation, second global model coefficients of a second global machine learning model, the second global machine learning model being configured for use by the first electronic entity as an updated local machine learning model and the second electronic entity as an updated global machine learning model in determining the performance metric for the first electronic entity and the second electronic entity within the network. In some implementations, the aggregation is produced based on an aggregation factor indicating an amount by which the second global model coefficients differ from the first global model coefficients. In some implementations, the aggregation factor is received as part of configuration parameters received from a server in the network.

Operation 240 includes controlling transmitting, by the first electronic entity to the second electronic entity, the second global model coefficients of the second global machine learning model. In some implementations, the first and second electronic entities are network nodes; the first global model coefficients are transmitted over an Xn interface. In some implementations, the first electronic entity is a network node distributed unit and the second electronic entity is a network node central unit; the first global model coefficients are transmitted over a F1 interface. In some implementations, the first and second electronic entities are user devices; the first global model coefficients are transmitted over a device-to-device link.

Operation 250 includes performing, by a first electronic entity of a plurality of electronic entities in a network, a training operation on a local dataset to produce local model coefficients of a local machine learning model, the local dataset being based on data collected by the first electronic entity of signals in the network, the local machine learning model being used by the first electronic entity in determining a performance metric for the first electronic entity within the network. For example, a user device in a network performs measurements of reference signal received power (RSRP) on reference signals in the serving cell of the user device or a neighbor cell. The user device may then use these measurements as training data for the updated local ML model.

In summary, the improved techniques are directed to enabling the aggregation of learned ML models with other ML models in a network by any electronic entity in a network, independent of a network topology. That is, whether a federated learning model is centralized or decentralized, the improved techniques allow each electronic entity in a network improve their ML models through aggregating other ML models trained by other electronic entities in the network.

The method of FIG. 2 may also include controlling receiving, from a server in the network, a set of configuration parameters; and selecting a second electronic entity of the plurality of electronic entities in the network based on the set of configuration parameters. That is, a server may transmit a set of configuration parameters to an electronic entity in the network that specify details about network topology; accordingly, the set of configuration parameters may identify electronic entities in the network with which the electronic entity may request a ML model.

In the method of FIG. 2, the set of configuration parameters may include an aggregation factor indicating an amount by which the second global model coefficients differ from the first global model coefficients. In some implementations, aggregating the local model coefficients and the first global model coefficients includes performing a weighted average of the local model coefficients and the first global model coefficients using a first weight and a second weight such that the first weight and the second weight sum to unity, the first weight being the aggregation factor. That is, under certain conditions (e.g., an origin identifier of the global ML model matches the origin identifier of the local ML model), the aggregation factor is a number between zero and unity. The aggregation multiplies the global model coefficients by the aggregation factor and the local model coefficients by unity minus the aggregation factor and adds the two products. In some implementations, the aggregation factor indicates that the local model coefficients are to be replaced with the first global model coefficients, the second global model coefficients being set equal to the first global model coefficients. That is, under certain conditions (e.g., an origin identifier of the global ML model does not match the origin identifier of the local ML model), the aggregation factor is equal to unity and the local ML model is exchanged for the first global ML model. In some implementations, the aggregation factor may vary during training a ML model.

In the method of FIG. 2, the set of configuration parameters may include a model update schedule, the model update schedule indicating times at which the first electronic entity controls transmitting requests for updates to the local ML model to electronic entities of the plurality of electronic entities, the electronic entities being selected based on the set of configuration parameters. In some implementations, the model update schedule indicates that the local ML model is to be updated periodically, and wherein the model update schedule includes a value of an update period. In some implementations, the model update schedule indicates that the local machine learning model is to be updated in response to a trigger event. For example, a trigger event may be an abrupt change in network conditions.

In the method of FIG. 2, the set of configuration parameters may include a network topology indicator indicating whether the second electronic entity is the server or a peer device to the first electronic entity. For example, when the network topology indicator indicates that the second electronic entity is a server,

In the method of FIG. 2, each of the local ML model and the first ML model may include a respective origin identifier identifying an initialization scheme used to generate that local machine learning model or global machine learning model. For example, if ML models are initialized with a seed value, the origin identifier may indicate the seed value. In this case, aggregating the local model coefficients and the first global model coefficients may include, in response to the origin identifier of the first global machine learning model being different from the origin identifier of the local machine learning model, setting the local model coefficients equal to the first global model coefficients.

In the method of FIG. 2, the set of configuration parameters may include a network topology indicator indicating whether the second electronic entity is the server or a peer device to the first electronic entity. In some implementations, when network topology indicator indicates that the second electronic entity is a server, the first global model coefficients of the first global machine learning model are received over a physical downlink shared channel and the second global model coefficients of the second global machine learning model are transmitted over a physical uplink shared channel. In such an implementation, the method of FIG. 2 includes controlling transmitting, to the second electronic entity, the second global model coefficients of the second global machine learning model to the server. In some implementations, the server includes a first server and a second server, the first server and the second server having separate data stores; this is useful when there are privacy concerns in sharing ML models. In such an implementation, the method of FIG. 2 controlling transmitting the second global model coefficients of the second global machine learning model to the server includes transmitting a first portion of the second global model coefficients to the first server and transmitting a second portion of the second global model coefficients to the second server.

In the method of FIG. 2, when network topology indicator indicates that the second electronic entity is a peer user device to the first electronic entity, the first global model coefficients of the first global machine learning model and the second global model coefficients of the second global machine learning model are respectfully received and transmitted over a device-to-device link. In some implementations, the method of FIG. 2 further comprises storing the second global model coefficients of the second global machine learning model prior to transmitting the second global model coefficients to the second electronic entity. In some implementations, the first electronic entity is a network node distributed unit, and the second electronic entity is a network node central unit; in such implementations, the first global model coefficients of the first global machine learning model and the second global model coefficients of the second global machine learning model are respectfully received and transmitted over a F1 interface. In some implementations, the first electronic entity and the second electronic entity are network nodes; in such implementations, the first global model coefficients of the first global machine learning model and the second global model coefficients of the second global machine learning model are respectfully received and transmitted over a Xn interface.

In the method of FIG. 2, the first global machine learning model may include a version identifier identifying a version number of the first global machine learning model. In this case, aggregating the local model coefficients and the first global model coefficients includes incrementing the version number of the first global machine learning model to produce a version identifier of the second global machine learning model. In some implementations, the version number identified by the version identifier of the first global machine learning model is equal to a version number identified by a version identifier of a previous global machine learning model; in such implementations, aggregating the local model coefficients and the first global model coefficients includes, in response to the version number identified by the version identifier of the first global machine learning model being equal to the version number identified by the version identifier of the previous global machine learning model, setting the second global model coefficients of the second global machine learning model equal to the first global model coefficients of the first global machine learning model.

At a high level, the improved techniques involve multiple electronic entities (e.g., clients) cooperatively learning to generate a global model. For this purpose, there is a configurable/controllable aggregation factor f, which may be a parameter set by a central learning orchestrator (e.g., a server), standardized factor, or dynamically selected by the clients. There may be multiple aggregation factors e.g., global aggregation factor f_{g} for model shared in global use and local aggregation factor fₗ used for formulating the local model. With proposed aggregation factor multiple models can be aggregated together to improve learning and model performance.

With the aggregation factor as introduced above, federated learning is not limited to certain communication topologies that might become rather complex for practical learning tasks, e.g., in radio access networks. Rather, clients may take turns in aggregating the global ML model. Clients may receive (e.g., download), aggregate, and transmit (e.g., upload) ML models as illustrated in FIG. 4. Alternatively, clients sharing their aggregated models to peers e.g., in circular network or in mesh network may form a global ML model. In the end, both approaches yield the similar results.

FIG. 4 is a diagram illustrating a centralized federated learning process 400 in which a global model is received from a server (e.g., second electronic entity) by clients (e.g., other electronic entities including a first electronic entity), the global model is updated by the clients and transmitted back to the server. As shown in FIG. 4, a central server is used for storing the aggregated model.

At 401, a client 410(3) (e.g., a user device) downloads a global ML model from a storage device of a server 420 and aggregates the global ML model with a local ML model based on an aggregation factor to produce an adjusted global ML model. The aggregation factor may be a number between zero and unity, inclusive. The aggregation factor, in some implementations, is provided in a set of configuration parameters and received from a server (maybe, but not necessarily, server 420). The clients 420(1-2) may also be downloading and aggregating the global ML model from the server 420.

It is noted that the aggregation factor controls a rate of change made to global and local ML models. The aggregation factor may be indicative of a difference between local and global ML models. With a high aggregation factor, the global ML model is weighted more and with low aggregation factor, the local ML model is weighted more.

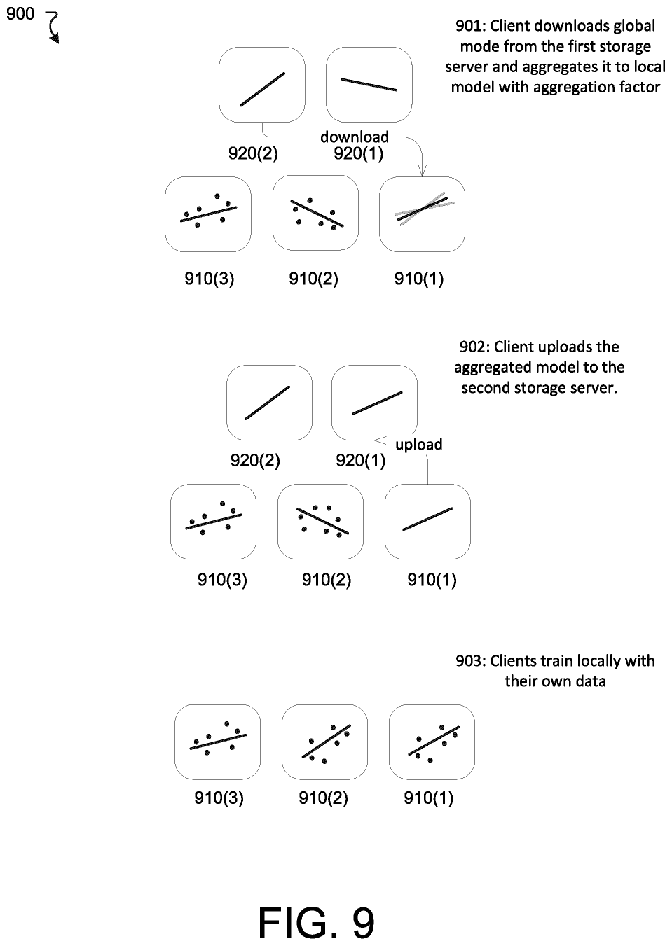

At 402, the client 401(3) uploads the adjusted global ML model to the server 420. It is noted that the uploading involves sharing the local ML model of the client 410(3). In some cases, such sharing may evoke privacy concerns. As will be shown with regard to FIG. 9, such concerns may be addressed using multiple servers/

At 403, the clients 401(1-3) proceed to train their local ML models using collected data. In some implementations, the collected data include measurements of RSRP in their own and neighboring cells.

FIG. 5 is a diagram illustrating a decentralized federated learning process 500 in which a global ML model is received by a client from peer clients, the global ML model is updated by the client, and the updated global ML model transmitted back to the peer clients. As illustrated in FIG. 5, the process 500 may be performed in any kind of peer network topology (i.e., topology of connected clients and different type of server entities). Aggregation updates can be made in a circular manner or with a mesh network type of connections to peers (e.g., through Xn and F1 interfaces in cellular networks or using device-to-device links. In order to synchronize client ML models, one may use an aggregation factor of unity, when client joins/connects to network where pre-learned models exist already. Then shared initialization seeds are not needed. Alternatively, model origin ID (or initialization seed) may be shared, specified in standards, or parameterized by entity acting as a server.

At 501, a client 510(2) obtains a global ML model from a peer client 510(3) and aggregates the global ML model with its local ML model using the aggregation factor to produce an adjusted global ML model. In some implementations, the peer client 510(3) transmits the global ML model to the peer client. The aggregation factor may be a number between zero and unity, inclusive. The aggregation factor, in some implementations, is provided in a set of configuration parameters and received from a server (not shown). For client 510(2), the adjusted global ML model becomes its adjusted local ML model.

At 502, the clients 510(1-3) train their respective local ML models using collected data. In some implementations, the collected data include measurements of RSRP in their own and neighboring cells.

At 503, the client 510(1) obtains a global ML model from client 510(2) (which is the updated global ML model that has been changed via the training in 502). The client 510(1) then aggregates the global ML model from client 510(2) using the aggregation factor. It is noted that the communication between clients in 501 and 503 are sent over device-to-device connections.

In some implementations, a global ML model has at least one of a version identifier (versionID) and an origin identifier (originID).
If versionID has not been changed, then client may skip aggregation at least until the ML model version ID has changed due to aggregation done with another client's ML model. Version ID may be increased after every global model update (performed with aggregation).
   For example, a formulation for incrementing the versionID after an update is versionID=mod (versionID+1, maxID).
OriginID may be used to link a ML model to a particular initialization method. This allows a client to identify whether its local ML model may be aggregated with the global ML model or not. For example, if a global ML model received at a client has a different origin ID from its local ML model, then the client may use an aggregation factor of unity to replace its local ML model with the global ML model. Otherwise, the client may perform aggregation using an aggregation factor less than unity. OriginID may be also used for defining geographic or other areas/environments where ML models may be aggregated. For example, if learning environments differ too much, then different originID may be used in order to preclude aggregation (or alternatively, mandate to use aggregation factor of unity to fully replace the local ML model with the global ML model that is valid in the current area/environment).

In the above-described improved techniques, clients update a global ML model individually. The global ML model may be stored in a server or it can be understood as being circulated within a decentralized peer network. In some implementations, multiple clients update ML models in parallel in decentralized peer network.

Regardless of whether the global ML model is centrally stored or passed forward in peer-to-peer manner, in every neural network aggregation occasion at the client the following equation may be used for updating all neural network weights w_{g}∈W_{g} (connecting the neurons) with aggregation factor as follows:

$${w}_{g} ← ( 1 - {γ}_{g} ) {w}_{l}^{k} + {γ}_{g} {w}_{g} ,$$

where w_{g} represents the global ML model coefficient (obtained from peer client or from the storage server) and wₗ^{k}∈Wₗ^{K} is local model coefficient of kth client doing the aggregation. The global ML model aggregation factor is 0≤γ_{g}≤1. After the global ML model update the kth local model may be updated to a global one wₗ^{k}←W_{g} or kth client may have a separate aggregation factor γₗ for its local model weights wₗ^{k}. The aggregation factor may be also embedded in different aggregation equations.

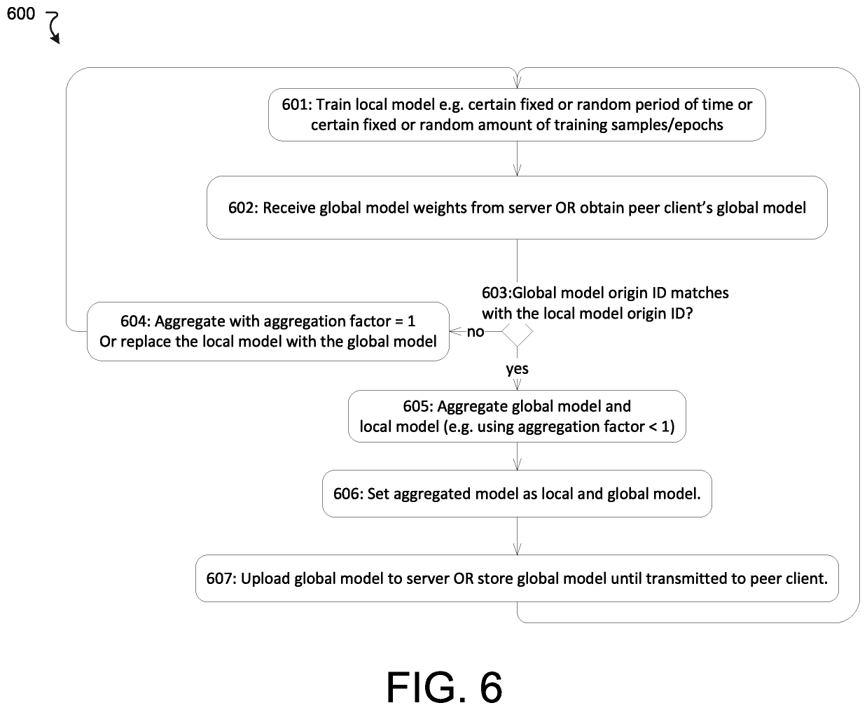

FIG. 6 is a flow chart illustrating a process 600 of updating a client model in a basic aggregation loop. Each client participating to federated learning may update their respective ML models periodically between time periods or number of training samples obtained. In some implementations, a random timer or random counter for training occasions may be used. Once aggregation is completed, a client may begin using the aggregated ML model as local ML model; the client uploads the same aggregated ML model to the server as an updated global ML model. Alternatively, if learning is performed in peer-to-peer style, then the client may provide the aggregated ML model to a connected peer.

At 601, a client trains a local ML model. In some implementations, the ML model is trained at a specified or random period of time. In some implementations, the ML model is trained based on a number of samples in training data.

At 602, the client downloads global ML model coefficients from either a server or a peer client's global ML model.

At 603, the client determines whether the originID of the global ML model matches the globalID of the local ML model.

At 604, the global ML model does not match the globalID of the local ML model. Accordingly, the client performs aggregation using an aggregation factor of unity. Alternatively, the client replaces the local ML model with the global ML mode.

At 605, the global ML model matches the globalID of the local ML model.

Accordingly, the client aggregates the local ML model and the global ML model using an aggregation factor between zero and unity.

At 606, the client sets the aggregated ML model as an adjusted local ML model and an adjusted global ML model.

At 607, the client uploads the adjusted global ML model to the server in a centralized learning environment. Alternatively, in a decentralized environment, the client stores the adjusted global ML model until it is transmitted to a peer client.

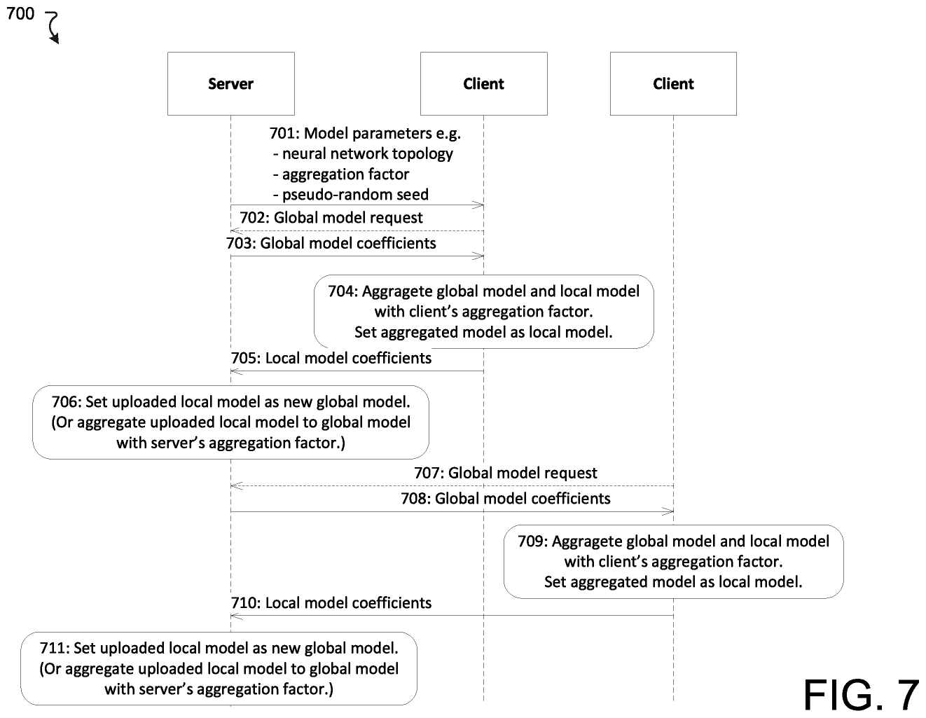

FIG. 7 is a sequence diagram illustrating a process 700 of updating a client ML model that involves storing a global ML model at a server. In FIG. 7, a server stores a global model and may configure clients with parameters such as aggregation factor, update periodicity, and neural network topology (i.e., number of neural network layers and number of neurons per layer). If multiple ML models are used for different purposes, then the ML models may be differentiated with an identification value. There may also be a global ML model request message if clients are timing or counting to an update periodicity. Alternatively, the server may trigger updates.

At 701, the server sends each client a set of configuration parameters for configuring the aggregation process. In some implementations, the set of configuration parameters includes any of the following:
neural network topology,
aggregation factor,
pseudo-random seed,
update periodicity,
model identifier.
   The above list of possible configuration parameters is not exhaustive and may include other parameters. It is noted that the pseudo-random seed is not needed if the server provides pre-learned weights, i.e., the client is not starting from a scratch. Also, the neural network topology is not needed beforehand if the client begins learning after receiving the global model for the first time.

At 702, a first client transmits a global ML model request to the server. At 703, the server transmits global ML model coefficients to the first client. In some implementations, the global ML model request includes a model identifier. In some implementations, the global ML model coefficients include a model identifier, a versionID, and/or an originID.

At 704, the first client aggregates the global ML model and its local ML model using the aggregation factor to produce an updated ML model. The first client then sets the local ML model to the updated ML model. In some implementations, the initial update by the first client may be performed using an aggregation factor of unity to avoid degrading the global ML model. Moreover, the first client need not use a common seed for model initialization.

At 705, the first client transmits its local ML model (updated) to the server. At 706, the server aggregates the uploaded local ML model with a stored global ML model using the aggregation factor. In some implementations, the server sets the uploaded local ML model as the global ML model.

At 707, a second client transmits a global ML model request to the server. At 708, the server transmits global ML model coefficients to the second client. In some implementations, the global ML model request includes a model identifier. In some implementations, the global ML model coefficients include a model identifier, a versionID, and/or an originID.

At 709, the second client aggregates the global ML model and its local ML model using the aggregation factor to produce an updated ML model. The second client then sets the local ML model to the updated ML model.

At 710, the second client transmits its local ML model (updated) to the server. At 711, the server aggregates the uploaded local ML model with a stored global ML model using the aggregation factor. In some implementations, the server sets the uploaded local ML model as the global ML model.

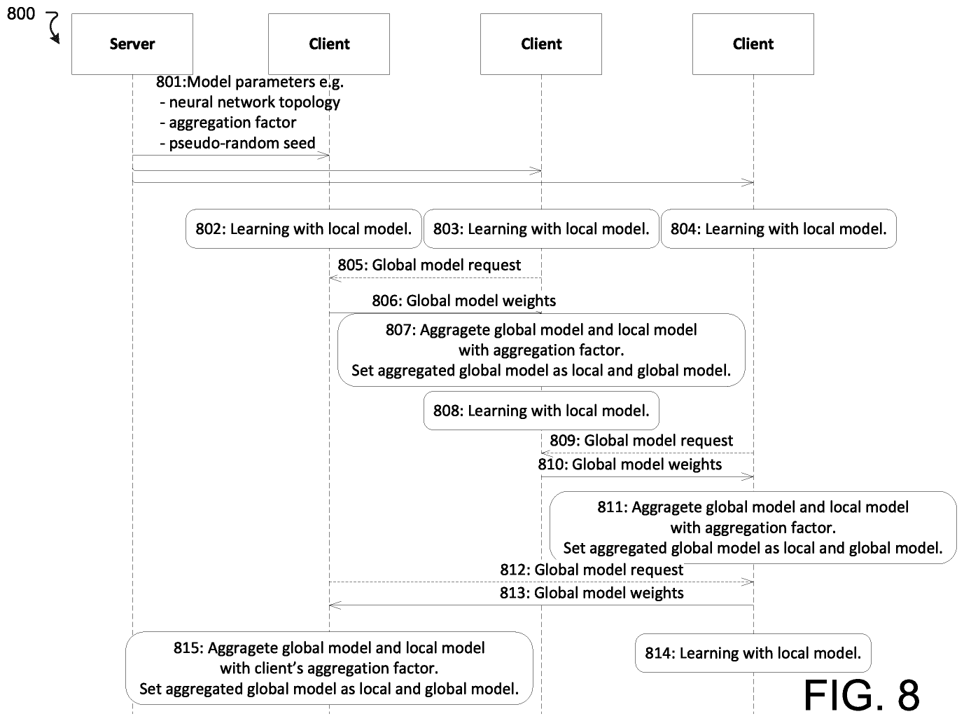

FIG. 8 is a flow chart illustrating a sequence diagram illustrating a process 800 of updating a client model that involves peer-to-peer model circulation among peer clients. As shown in FIG. 8, there may still be a server which controls learning by providing a set of configuration parameters. Global ML model requests may use an identification value to differentiate between multiple ML models that may be used simultaneously.

At 801, the server sends each of a first client, a second client, and a third client a set of configuration parameters for configuring the aggregation process. In some implementations, the set of configuration parameters includes any of the following:
neural network topology,
aggregation factor,
pseudo-random seed,
update periodicity,
model identifier.
   The above list of possible configuration parameters is not exhaustive and may include other parameters.

At 802, 803, and 804, the first client, the second client, and the third client, respectively, perform training operations using their local ML models.

At 805, the second client transmits a request for a global ML model to the first client; in some implementations, the request includes a model identifier. At 806, in response, the first client transmits global ML model coefficients; in some implementations, the global ML model coefficients include a model identifier, a versionID, and/or an originID. It is noted that the clients may initialize their respective ML models with the same initial seed or the initial aggregation may be performed using an aggregation factor of unity.

At 807, the second client aggregates the global ML model and its local ML model using the aggregation factor. In some implementations, the second client sets the uploaded local ML model as the global ML model. At 808, the second client performs learning with the local ML model.

At 809, the third client transmits a request for a global ML model to the second client; in some implementations, the request includes a model identifier. At 810, in response, the second client transmits global ML model coefficients to the third client; in some implementations, the global ML model coefficients include a model identifier, a versionID, and/or an originID. It is noted that the clients may initialize their respective ML models with the same initial seed or the initial aggregation may be performed using an aggregation factor of unity.

At 811, the third client aggregates the global ML model and its local ML model using the aggregation factor. In some implementations, the second client sets the uploaded local ML model as the global ML model.

At 812, the first client transmits a request for a global ML model to the third client; in some implementations, the request includes a model identifier. At 813, in response, the third client transmits global ML model coefficients to the first client; in some implementations, the global ML model coefficients include a model identifier, a versionID, and/or an originID. It is noted that the clients may initialize their respective ML models with the same initial seed or the initial aggregation may be performed using an aggregation factor of unity.

At 814, the third client performs learning with the local ML model. At 815, the first client aggregates the global ML model and its local ML model using the aggregation factor. In some implementations, the second client sets the uploaded local ML model as the global ML model.

In the following, clients may be understood to be network nodes (e.g., gNBs) or user devices (UEs). A server, if present, may be understood as a gNB or other network entity. Parameterization for proposed federated learning may be standard values or standardized configurable parameters.

Global models may be transmitted over shared channels (PDSCH and PUSCH). Moreover, UEs may use device-to-device (D2D) links for passing global models to each other. If gNBs are perform federated learning over Xn interfaces between separate gNBs, F1 interfaces between gNB distributed units (gNB-DUs) and central units (gNB-CUs) may be used for distributing a global ML model to neighboring gNBs. Alternatively, gNBs may use common server(s) for aggregating the models. Hence, the improved techniques are not limited to any particular federated learning network topology. For example, interconnected gNBs from a common vendor may use the improved federated learning by implementation (even without new entities or heavy coordination in a mesh fashion), but if multi-vendor network entities or UEs are considered as clients, then standardization is required.

As mentioned previously, there may be issues involving data privacy with distributed learning method. The improved techniques may be used without sharing the raw training data as well as without sharing the client's local neural networks. In federated learning, the local model may be given to a central entity or to a peer node for aggregation. In the improved techniques, the learning data as well as the local model stay at the client. Models may be passed to a different client after aggregation as shown in FIG. 5.

Another way to distribute models such that servers cannot reproduce clients' local ML models is to have multiple storage server entities as shown in FIG. 9. Then clients would upload the aggregated model to a different server i.e., not to the one where they downloaded the global model. Server selection for downloading and uploading could be pre-configured or randomly selected. With these methods it would be difficult to reconstruct the same model or the private data that certain client on which the local ML model is based.

FIG. 9 is a diagram illustrating a centralized federated learning process 900 in which a global model is shared among more than one server.

At 901, a client 910(1) receives a global ML model from a server 920(2). After receipt of the global ML model, the client 910(1) aggregates the global ML model with a local ML model using an aggregation factor to produce an updated ML model.

At 902, the client 910(1) transmits the updated ML model to a server 920(1) different from server 920(2). In this way, the local ML model of client 910(1) cannot be deduced by having access to either server 920(1) or 920(2) alone.

At 903, the clients 910(1-3) train their respective local ML models using their own collected data.

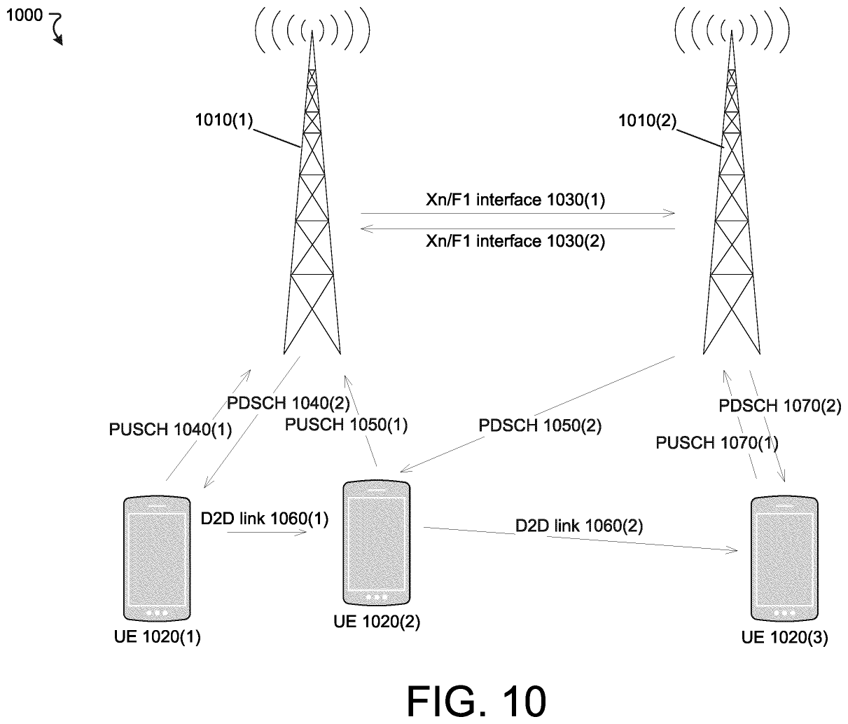

FIG. 10 is a diagram illustrating a sharing of a global model within a cellular network 1000. As shown in FIG. 10:
A UE 1020(1) may request global ML model coefficients from a gNB 1010(1) over a PUSCH 1040(1); the gNB 1010(1) may then transmit the global ML model coefficients over a PDSCH 1040(2).
A UE 1020(2) may request global ML model coefficients from the gNB 1010(1) over a PUSCH 1050(1); another gNB 1010(2) may then transmit the global ML model coefficients over a PDSCH 1050(2).
The UE 1020(1) may request global ML model coefficients from the UE 1020(2) over a D2D link 1060(1). The UE 1020(2) may transmit the global ML model coefficients to a UE 1020(3) over D2D link 1060(2).
The UE 1020(1) may request global ML model coefficients from the gNB 1010(2) over a PUSCH 1070(1); the gNB 1010(2) may then transmit the global ML model coefficients over a PDSCH 1070(2).
The gNB 1010(1) may request global ML model coefficients from the gNB 1010(2) over a Xn/F1 interface 1030(1); the gNB 1010(2) may then transmit the global ML model coefficients over a Xn/F1 interface 1030(2).

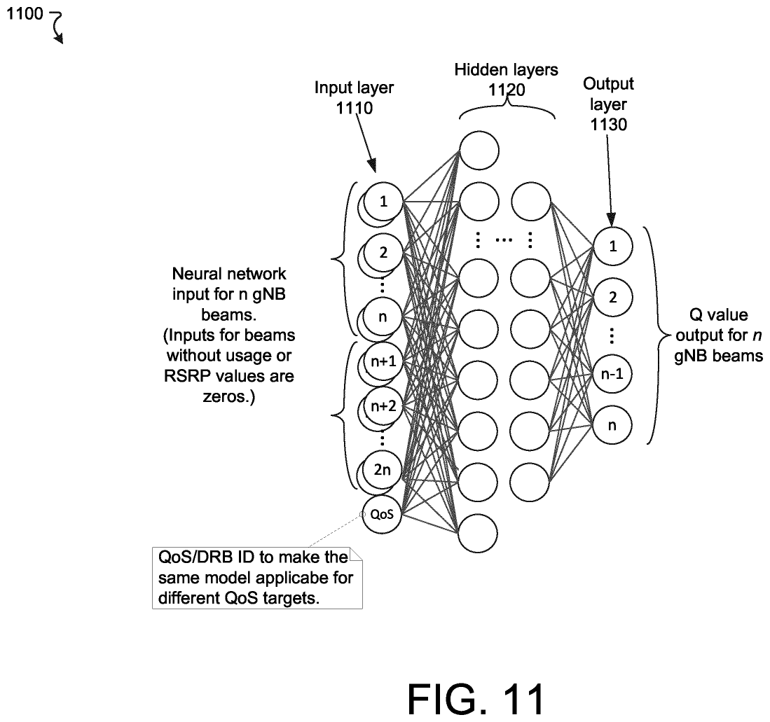

As an example of the improved techniques, the improved techniques were applied to a deep Q network (DQN) based beam selection, where mmW FR2 (at 30 GHz) gNBs try to select optimal serving beams for best effort UEs as well as latency critical UEs at the same time. It may be assumed that FR2 gNB may use only one beam at a time due to limited number of RF chains, which is a practical limitation at least in mmW frequencies. A global ML model is updated in turns by each gNB approximately with 200 millisecond periodicity. A random number generator is used for providing random ˜50 millisecond variance to aggregations done by each gNB client. Local learning at the gNB is done continuously when new CSI reports are received from the UEs. CSI reporting periodicity is 5 milliseconds. Training utilizes reported beam RSRP values as well as beam usage counter values as an input (See FIG. 11.) Rewards are based on throughput for the best effort UEs. For the latency critical UEs, a transmission buffer status and packet delays are used to formulate the reward function.

First, one initializes neural network weights of all clients (existing in gNBs) with the same pseudo-random seed. (Such shared seed initialization is not needed if the first update made by each gNB is done with aggregation rate of unity. This may yield the same outcome.) As discussed previously, in federated learning studies using a shared seed initialization, averaging the ML model coefficients produced a significant reduction in the loss on the total training set. Error! Reference source not found. Hence, even though a similar central averaging of multiple models is not performed, it is expected that shared seed helps when local and global are being aggregated with proposed aggregation factor.

FIG. 11 is a diagram illustrating a neural network 1100 used in beam selection. As shown in FIG. 11, the neural network 1100 includes an input layer 1110, hidden layers 1120, and an output layer 1130.

As shown in FIG. 11, the input layer 1110 includes 2 n+1 coefficients. The first n coefficients indicate beam usage for a set of n beams emitted by gNBs in the network. It is noted that beam usage for the jth beam may be derived from scheduling counts (count [j]/count_max). The second n coefficients indicate user-reported RSRPs for the best several beams. The final coefficient indicates quality of service (QOS) or data radio bearer (DRB) identifier. It is noted that QoS ID or DRB ID differentiates data types e.g., from the best effort or latency critical data requiring different kind of service.

The output layer 1130 includes n coefficients indicating a Q value output for the set of n beams emitted by the gNB. Accordingly, the neural network 1100 selects a beam based on a Q value prediction based on beam usage, measured RSRP, and QOS/DRB ID.

Based on the parameter values stated above, aggregation factors 0.2 and 0.8 show significant gain in learning when gNBs update the global ML model. A small aggregation factor takes only a small percentage of global ML model into account while large aggregation factor takes only a small percentage of the local ML model into account when ML models are aggregated. Using an aggregation factor of 0.5 was not seen to accelerate the learning significantly because neural network gradients may be changed with excessively large steps in the beginning. Experiments showed that the performance of pre-learned model first trained with 0.2 aggregation factor and once matured further trained with 0.5 aggregation factor had better performance over static aggregation factors, no aggregation factor, and a disabled ML. As can be observed, once a ML model matures, then an aggregation factor of 0.5 works well because the ML models of the clients are already close to a common target global ML model.

To summarize, the improved techniques include the following.
Specifying/parameterizing aggregation factor for global model updates, wherein the global model is updated with the local model using said aggregation factor.
Downloading the global model from the server entity, aggregating the global model with the local model, uploading the updated local model to the server entity.
Obtaining the global model from the peer entity, aggregating the global model with the local model, passing the updated global model to different peer entity.
Learning clients updating model in turns:
   Between specified time steps and/or between random time steps.
   Between specified number and/or between random number of local model training occasions.
Performing the first aggregation with aggregation factor of 1.
Starting learning with high value<1 (but close to 1) or low aggregation factor>0 (but close to 0), moving towards 0.5 aggregation factor once training has matured.
Having separate aggregation factors for the global ML model (to be uploaded to the server or passed forward to another peer entity) and local ML model (to be used for local learning).
After model aggregation, passing the aggregated ML model at the client to a different server or peer client (i.e. not the same from where the global model was acquired).
Using above-described ML model aggregation methods for aggregating ML models used by more than one network entity (such as gNB) and/or UE.
A gNB having feature specific model IDs for its models that may be used for identifying model requested by neighbor gNB or UE.
After a ML model is updated, the gNB broadcasts (pages) or transmits current model version ID to other gNBs or UEs
Having an origin ID to prevent aggregating models initiated differently (e.g. with different pseudo-random generator seeds) or used in different geographical areas, including
   forbidding aggregating models with different origin ID,
   transmitting origin ID together with the model in peer-to-peer model transfers,
   providing origin ID by the network entity such as gNB in centralized model storing,
   Deriving the origin ID alternatively from pseudo-random seed or other IDs relative to location (such as cell ID, gNB ID, global gNB ID, tracking area identity (TAI), and/or NR global cell global identity NCGI).
When a new UE connects or a new gNB is deployed, obtaining the model and performing aggregation with high aggregation factor (e.g. 1), using lower aggregation factor between 0 and 1 for later aggregations for global model updates.
Specifying IDs for models used by different features (using the improved techniques).
   gNB or UE may request desired model with specified ID value
      Certain ID may be used e.g. for learning beam selection
      Also other optimization use cases may have their own model IDs, such as transmission power control optimization, handover optimization, carrier aggregation optimization, discontinuous transmission/reception optimization, etc.
gNB or other radio network entity acting as a server entity storing the model
gNBs and/or UEs acting as peer entities performing model aggregations and updates
gNB configuring aggregation factor and/or aggregation periodicity parameters for UEs using e.g. RRC signaling
Additionally there are some 3GPP related embodiments (not in any particular order).

Proposed identifier methods also allow standardization of sharing UE-vendor specific proprietary models between UEs through gNBs:
UE download/upload proprietary models using certain UE vendor specific model identifier/
   This allows UE vendors to develop own proprietary ML models and aggregate said models between devices (operating e.g. within the same area) by using network entities as servers storing the global model.

Network entity does not need to know the exact purpose of the model.

Some further examples will be provided.

Example 1. A method may include
controlling transmitting, by a first electronic entity (e.g., client 410(1)) of a plurality of electronic entities (clients 410(1-3)) in a network to a second electronic entity (e.g., client 410(2)), in the network, a request for first global model coefficients of a first global machine learning model (e.g., request 702),
controlling receiving, by the first electronic entity from the second electronic entity, the first global model coefficients of the first global machine learning model,
aggregating, by the first electronic entity, the local model coefficients and the first global model coefficients to produce, as an aggregation, second global model coefficients of a second global machine learning model (e.g., local model coefficients 705), the second global machine learning model being configured for use by the first electronic entity as an updated local machine learning model and the second electronic entity as an updated global machine learning model in determining the performance metric for the first electronic entity and the second electronic entity within the network,
control transmitting, by the first electronic entity to the second electronic entity, the second global model coefficients of the second global machine learning model, and
performing, by the first electronic entity, a training operation (e.g., 802, 803, 804) on a local dataset to produce updated local model coefficients (e.g., hidden layers 1120) of an updated local machine learning model (e.g., neural network 1100), the local dataset being based on data collected by the first electronic entity of signals in the network, the local machine learning model being used by the first electronic entity in determining a performance metric (e.g., Q value in output layer 1130) for the first electronic entity within the network.

Example 2: According to an example implementation of example 1, further comprising controlling receiving, from a server (e.g., server 420) in the network, a set of configuration parameters (e.g., configuration parameters 801); and selecting a second electronic entity of the plurality of electronic entities in the network based on the set of configuration parameters (e.g., server 420 or client 510(2)).

Example 3: According to an example implementation of example 2, wherein the set of configuration parameters includes an aggregation factor (in configuration parameters 701) indicating an amount by which the second global model coefficients differ from the first global model coefficients.

Example 4: According to an example implementation of example 3, wherein aggregating the local model coefficients and the first global model coefficients includes performing a weighted average of the local model coefficients and the first global model coefficients using a first weight and a second weight such that the first weight and the second weight sum to unity, the first weight being the aggregation factor.

Example 5: According to an example implementation of examples 3 to 4, wherein the aggregation factor indicates that the local model coefficients are to be replaced with the first global model coefficients, the second global model coefficients being set equal to the first global model coefficients.

Example 6: According to an example implementation of examples 3 to 5, wherein performing the training operation on the local dataset includes performing an initial training operation using an initial value of the aggregation factor and performing a subsequent training operation using a different value of the aggregation factor.

Example 7: According to an example implementation of examples 2 to 6, wherein the set of configuration parameters includes a model update schedule, the model update schedule indicating times at which the first electronic entity controls transmitting requests for updates to the local machine learning model to electronic entities of the plurality of electronic entities, the electronic entities being selected based on the set of configuration parameters.

Example 8: According to an example implementation of example 7, wherein the model update schedule indicates that the local machine learning model is to be updated periodically, and wherein the model update schedule includes a value of an update period.

Example 9: According to an example implementation of example 7, wherein the model update schedule indicates that the local machine learning model is to be updated in response to a trigger event.

Example 10: According to an example implementation of examples 2 to 9, wherein each of the local machine learning model and the first machine learning model includes a respective origin identifier identifying an initialization scheme used to generate that local machine learning model or global machine learning model, and wherein aggregating the local model coefficients and the first global model coefficients includes, in response to the origin identifier of the first global machine learning model being different from the origin identifier of the local machine learning model, setting the local model coefficients equal to the first global model coefficients.

Example 11: According to an example implementation of examples 2 to 10, wherein the set of configuration parameters includes a network topology indicator indicating whether the second electronic entity is the server or a peer device to the first electronic entity.

Example 12: According to an example implementation of example 11, wherein the second global model coefficients of the second global machine learning model are transmitted to the second electronic entity over a physical uplink shared channel.

Example 13: According to an example implementation of example 12, wherein the server includes a first server and a second server, the first server and the second server having separate data stores, and wherein controlling transmitting the second global model coefficients of the second global machine learning model to the server includes transmitting a first portion of the second global model coefficients to the first server and transmitting a second portion of the second global model coefficients to the second server.

Example 14: According to an example implementation of example 11, wherein the network topology indicator indicates that the second electronic entity is a peer device to the first electronic entity.

Example 15: According to an example implementation of example 12, wherein the first electronic entity and the second electronic entity are user devices, and wherein the second global model coefficients of the second global machine learning model are transmitted over a device-to-device link.

Example 16: According to an example implementation of examples 11, 14, or 15, further comprising storing the second global model coefficients of the second global machine learning model prior to transmitting the second global model coefficients to the second electronic entity.

Example 17: According to an example implementation of example 14, wherein the first electronic entity is a network node distributed unit and the second electronic entity is a network node central unit, and wherein the second global model coefficients of the second global machine learning model are transmitted over a F1 interface.

Example 18: According to an example implementation of example 14, wherein the first electronic entity and the second electronic entity are network nodes, and wherein the second global model coefficients of the second global machine learning model are transmitted over a Xn interface.

Example 19: According to an example implementation of examples 1-11, wherein the first global machine learning model also includes a version identifier identifying a version number of the first global machine learning model, and wherein aggregating the local model coefficients and the first global model coefficients includes incrementing the version number of the first global machine learning model to produce a version identifier of the second global machine learning model.

Example 20: According to an example implementation of example 19, wherein the version number identified by the version identifier of the first global machine learning model is equal to a version number identified by a version identifier of a previous global machine learning model, and wherein aggregating the local model coefficients and the first global model coefficients includes, in response to the version number identified by the version identifier of the first global machine learning model being equal to the version number identified by the version identifier of the previous global machine learning model, setting the second global model coefficients of the second global machine learning model equal to the first global model coefficients of the first global machine learning model.

Example 21: An apparatus may include at least one processor (e.g., processor 1204) and at least one memory (e.g., 1206) including computer program code, the at least one memory and the computer program code configured to cause the apparatus at least to:
control transmitting, by a first electronic entity of a plurality of electronic entities in a network to a second electronic entity in the network, a request for first global model coefficients of a first global machine learning model;
control receiving, by the first electronic entity from the second electronic entity, the first global model coefficients of the first global machine learning model;
aggregate, by the first electronic entity, the local model coefficients and the first global model coefficients to produce, as an aggregation, second global model coefficients of a second global machine learning model, the second global machine learning model being configured for use by the first electronic entity as an updated local machine learning model and the second electronic entity as an updated global machine learning model in determining the performance metric for the first electronic entity and the second electronic entity within the network;
control transmitting, by the first electronic entity to the second electronic entity, the second global model coefficients of the second global machine learning model; and
perform, by the first electronic entity, a training operation on a local dataset to produce updated local model coefficients of an updated local machine learning model, the local dataset being based on data collected by the first electronic entity of signals in the network, the local machine learning model being used by the first electronic entity in determining a performance metric for the first electronic entity within the network.

Example 22: An apparatus comprising means for performing a method of any of examples 1-20.

Example 23: A computer program product including a non-transitory computer-readable storage medium and storing executable code that, when executed by at least one data processing apparatus, is configured to cause the at least one data processing apparatus to perform a method of any of examples 1 to 20.

### List of Example Abbreviations

CSI Channel State Information
DQN Deep Q Network
DRB Data Radio Bearer
ML Machine Learning gNB 5G-NR Base Station
mmW millimeter Wave
NR New Radio
PDSCH Physical Downlink Shared Channel
Physical Uplink Shared Channel PUSCH
RB Resource Block
RL Reinforcement Learning
RSRP Reference Signal Received Power
RSRQ Reference Signal Received Quality
RSSI Received Signal Strength Indicator
SINR Singal-to-Interference-Plus-Noise Ratio
TTI Transmission Time Interval
UE User Equipment/Device

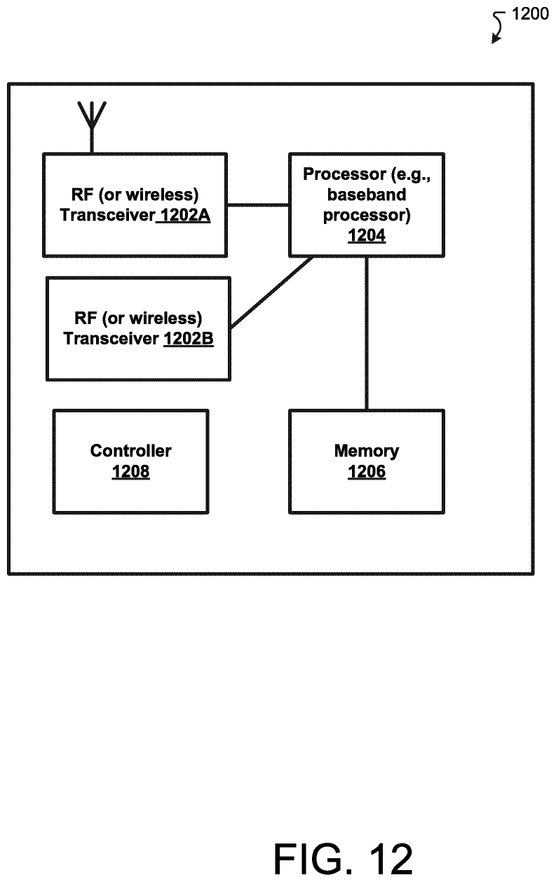

FIG. 12 is a block diagram of a wireless station (e.g., AP, BS, e/gNB, NB-IoT UE, UE or user device) 1200 according to an example implementation. The wireless station 1200 may include, for example, one or multiple RF (radio frequency) or wireless transceivers 1202A, 1202B, where each wireless transceiver includes a transmitter to transmit signals (or data) and a receiver to receive signals (or data). The wireless station also includes a processor or control unit/entity (controller) 1204 to execute instructions or software and control transmission and receptions of signals, and a memory 1206 to store data and/or instructions.

Processor 1204 may also make decisions or determinations, generate slots, subframes, packets or messages for transmission, decode received slots, subframes, packets or messages for further processing, and other tasks or functions described herein. Processor 1204, which may be a baseband processor, for example, may generate messages, packets, frames or other signals for transmission via wireless transceiver 902 (1202A or 1202B). Processor 1204 may control transmission of signals or messages over a wireless network, and may control the reception of signals or messages, etc., via a wireless network (e.g., after being down-converted by wireless transceiver 902, for example). Processor 1204 may be programmable and capable of executing software or other instructions stored in memory or on other computer media to perform the various tasks and functions described above, such as one or more of the tasks or methods described above. Processor 1204 may be (or may include), for example, hardware, programmable logic, a programmable processor that executes software or firmware, and/or any combination of these. Using other terminology, processor 1204 and transceiver 902 together may be considered as a wireless transmitter/receiver system, for example.

In addition, referring to FIG. 12, a controller (or processor) 1208 may execute software and instructions, and may provide overall control for the station 1200, and may provide control for other systems not shown in FIG. 12 such as controlling input/output devices (e.g., display, keypad), and/or may execute software for one or more applications that may be provided on wireless station 1200, such as, for example, an email program, audio/video applications, a word processor, a Voice over IP application, or other application or software.

In addition, a storage medium may be provided that includes stored instructions, which when executed by a controller or processor may result in the processor 1204, or other controller or processor, performing one or more of the functions or tasks described above.

According to another example implementation, RF or wireless transceiver(s) 1202A/1202B may receive signals or data and/or transmit or send signals or data. Processor 1204 (and possibly transceivers 1202A/1202B) may control the RF or wireless transceiver 1202A or 1202B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G uses multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall as intended in the various embodiments.

1-42. (canceled)

43. An apparatus, comprising:
at least one processor; and
at least one memory including computer program code;
the at least one memory and the computer program code configured to cause the apparatus at least to:
control transmitting, by a first electronic entity of a plurality of electronic entities in a network to a second electronic entity in the network, a request for first global model coefficients of a first global machine learning model;
control receiving, by the first electronic entity from the second electronic entity, the first global model coefficients of the first global machine learning model;
aggregate, by the first electronic entity, local model coefficients of a local machine learning model and the first global model coefficients to produce, as an aggregation, second global model coefficients of a second global machine learning model;
control transmitting, by the first electronic entity to the second electronic entity, the second global model coefficients of the second global machine learning model; and
perform, by the first electronic entity, a training operation on the second global machine learning model to produce updated local model coefficients of an updated local machine learning model using a local dataset based on data collected by the first electronic entity of signals in the network, the updated local machine learning model being used by the first electronic entity in determining a performance metric for the first electronic entity in the network.

44. The apparatus as in claim 43, wherein the at least one memory and the computer program code configured to cause the apparatus at least to:
control receiving, from a server in the network, a set of configuration parameters; and
select the second electronic entity of the plurality of electronic entities in the network based on the set of configuration parameters.

45. The apparatus as in claim 43, wherein the at least one memory and the computer program code configured to cause the apparatus at least to:
control receiving, from a server in the network, a set of configuration parameters;
select the second electronic entity of the plurality of electronic entities in the network based on the set of configuration parameters, and wherein the set of configuration parameters includes an aggregation factor indicating an amount by which the second global model coefficients differ from the first global model coefficients.

46. The apparatus as in claim 43, wherein the at least one memory and the computer program code configured to cause the apparatus at least to:
control receiving, from a server in the network, a set of configuration parameters; select the second electronic entity of the plurality of electronic entities in the network based on the set of configuration parameters, and wherein the set of configuration parameters includes a model update schedule, the model update schedule indicating times at which the first electronic entity controls transmitting requests for updates to the local machine learning model to electronic entities of the plurality of electronic entities, the electronic entities being selected based on the set of configuration parameters.

47. The apparatus as in claim 43, wherein the at least one memory and the computer program code configured to cause the apparatus at least to:
control receiving, from a server in the network, a set of configuration parameters; select the second electronic entity of the plurality of electronic entities in the network based on the set of configuration parameters, wherein each of the local machine learning model and the first machine learning model include a respective origin identifier identifying an initialization scheme used to generate that local machine learning model or global machine learning model, and
wherein the at least one memory and the computer program code configured to cause the apparatus at least to aggregate the local model coefficients and the first global model coefficients is further configured to cause the apparatus at least to:
in response to the origin identifier of the first global machine learning model being different from the origin identifier of the local machine learning model, set the local model coefficients equal to the first model coefficients.

48. The apparatus as in claim 43, wherein the at least one memory and the computer program code configured to cause the apparatus at least to:
control receiving, from a server in the network, a set of configuration parameters; select the second electronic entity of the plurality of electronic entities in the network based on the set of configuration parameters, and wherein the set of configuration parameters includes a network topology indicator indicating whether the second electronic entity is the server or a peer device to the first electronic entity.

49. The apparatus as in claim 43, wherein the at least one memory and the computer program code configured to cause the apparatus at least to:
control receiving, from a server in the network, a set of configuration parameters; select the second electronic entity of the plurality of electronic entities in the network based on the set of configuration parameters, and wherein the set of configuration parameters includes a network topology indicator indicating that the second electronic entity is a server to the first electronic entity; and wherein the second global model coefficients of the second global machine learning model are transmitted to the second electronic entity over a physical uplink shared channel.

50. The apparatus as in claim 43, wherein the first global machine learning model also includes a version identifier identifying a version number of the first global machine learning model, and
wherein the at least one memory and the computer program code configured to cause the apparatus at least to aggregate the local model coefficients and the first global model coefficients is further configured to cause the apparatus at least to:
increment the version number of the first global machine learning model to produce a version identifier of the second global machine learning model.

51. A method, comprising:
controlling transmitting, by a first electronic entity of a plurality of electronic entities in a network to a second electronic entity in the network, a request for first global model coefficients of a first global machine learning model;
controlling receiving, by the first electronic entity from the second electronic entity, the first global model coefficients of the first global machine learning model;
aggregating, by the first electronic entity, the local model coefficients of a local machine learning model and the first global model coefficients to produce, as an aggregation, second global model coefficients of a second global machine learning model;
controlling transmitting, by the first electronic entity to the second electronic entity, the second global model coefficients of the second global machine learning model; and
performing, by the first electronic entity, a training operation on the second global machine learning model to produce updated local model coefficients of an updated local machine learning model using a local dataset based on data collected by the first electronic entity of signals in the network, the updated local machine learning model being used by the first electronic entity in determining a performance metric for the first electronic entity in the network.

52. The method as in claim 51, further comprising:
controlling receiving, from a server in the network, a set of configuration parameters; and
selecting a second electronic entity of the plurality of electronic entities in the network based on the set of configuration parameters.

53. The method as in claim 51, further comprising:
controlling receiving, from a server in the network, a set of configuration parameters;
selecting a second electronic entity of the plurality of electronic entities in the network based on the set of configuration parameters, and
wherein the set of configuration parameters includes an aggregation factor indicating an amount by which the second global model coefficients differ from the first global model coefficients.

54. The method as in claim 51, further comprising:
controlling receiving, from a server in the network, a set of configuration parameters;
selecting a second electronic entity of the plurality of electronic entities in the network based on the set of configuration parameters, and
wherein the set of configuration parameters includes a model update schedule, the model update schedule indicating times at which the first electronic entity controls transmitting requests for updates to the local machine learning model to electronic entities of the plurality of electronic entities, the electronic entities being selected based on the set of configuration parameters.

55. The method as in claim 51, further comprising:
controlling receiving, from a server in the network, a set of configuration parameters;
selecting a second electronic entity of the plurality of electronic entities in the network based on the set of configuration parameters, and
wherein each of the local machine learning model and the first machine learning model include a respective origin identifier identifying an initialization scheme used to generate that local machine learning model or global machine learning model, and wherein aggregating the local model coefficients and the first global model coefficients includes:
in response to the origin identifier of the first global machine learning model being different from the origin identifier of the local machine learning model, setting the local model coefficients equal to the first global model coefficients.

56. The method as in claim 51, further comprising:
controlling receiving, from a server in the network, a set of configuration parameters;
selecting a second electronic entity of the plurality of electronic entities in the network based on the set of configuration parameters, and
wherein the set of configuration parameters includes a network topology indicator indicating whether the second electronic entity is the server or a peer device to the first electronic entity.

57. The method as in claim 51, further comprising:
controlling receiving, from a server in the network, a set of configuration parameters;
selecting the second electronic entity of the plurality of electronic entities in the network based on the set of configuration parameters, wherein the set of configuration parameters includes a network topology indicator indicating that the second electronic entity is a server to the first electronic entity; and
wherein the second global model coefficients of the second global machine learning model are transmitted to the second electronic entity over a physical uplink shared channel.

58. The method as in claim 51, wherein the first global machine learning model also includes a version identifier identifying a version number of the first global machine learning model, and
wherein aggregating the local model coefficients and the first global model coefficients includes:
incrementing the version number of the first global machine learning model to produce a version identifier of the second global machine learning model.
